(19) United States
(12) Patent Application Publication
(10) Pub. No.: US 2008/0184019 A1
(43) Pub. Date: Jul. 31, 2008

(54) METHOD FOR EMBEDDING SHORT RARE CODE SEQUENCES IN HOT CODE WITHOUT BRANCH-AROUNDS

(75) Inventors: Ali I. Sheikh, Toronto (CA); Kevin A. Stoodley, Richmond Hill (CA)

Correspondence Address: HESLIN ROTHENBERG FARLEY & MESITI P.C., 5 COLUMBIA CIRCLE, ALBANY, NY, 12203, US

(73) Assignee: INTERNATIONAL BUSINESS MACHINES CORPORATION, Armonk, NY (US)

(21) Appl. No.: 11/668,755

(22) Filed: Jan. 30, 2007

(51) Int. Cl. G06F 9/30

(52) U.S. Cl. 712/244

(57) ABSTRACT

The problem of handling exceptionally executed code portions is improved through the practice of embedding handling instructions within other instructions, such as within their “immediate” fields. Such instructions are chosen to have short execution times. Most of the time these instructions are executed quickly without having to include jumps around them. Only rarely are the other portions of these specialized computer instruction needed or used.

### TECHNICAL FIELD

This invention relates in general to the coding of instructions to be executed in a computer or microprocessor having instructions of variable length. More particularly, the present invention is directed to a method for embedding rarely executed code sequences into code sequences which are frequently executed without concomitantly introducing longer execution times.

### BACKGROUND OF THE INVENTION

Computer programs usually have sequences for rare (cold) code that are executed under exceptional conditions. Sometimes these sequences of rare code occur in close vicinity of hot (frequently executed) code. The existence of this code in the vicinity of hot code requires a compiler, interpreter, assembler or programmer to branch around the rare sequence in the usual case. The branch-around causes a performance overhead on the frequently executed path. Alternatively, the compiler or programmer has an option to generate the rare code sequence in an out-of-line code sequence (outlining). This avoids the performance overhead but it adds complexity to the code and/or to the compiler, especially when the rare code sequences are small.

### SUMMARY OF THE INVENTION

The present invention is applicable to machines which have instructions of variable lengths. The invention uses the details of binary encoding of larger instructions to embed a sma11, rare code sequence within (a sequence of) larger (that is, longer length) instructions. The larger instructions are intelligently chosen to have no impact on the correct execution of the program, and thus they effectively operate as null operations or No-Ops (NOPs). They are chosen to be fast instructions that do not significantly impact the hot code path. In the rare case, when the rare code sequence needs to be executed, it is made reachable by branching into the middle of the larger instruction(s). This allows one to avoid the performance overhead of having to include branch-around instructions and also to avoid the complexity of outlining.

Thus, in accordance with the present invention, there is provided a method, system and program product for structuring instructions in a stored program computer having instructions of variable length. The invention includes the step of encoding an instruction executed on an exceptional basis that actually lies within one or more fields of a second instruction whose execution is substantially unaffected by coding present in this field. In essence, the present invention creates a form of computer instruction which has dual characteristics depending upon the point at which it is entered. Put another way, it is two instructions in one.

The advantages of the present invention are best realized when the exceptional condition being handled is less frequently encountered. However, it is noted that there are entire classes of instructions which are apt to produce exceptional conditions which need to be handled. These certainly include the arithmetic, logical and shifting operations, but there are many other types and groupings of instructions that also exhibit this characteristic. These include instructions that provide system administration functions, so-called “atomic instructions” such as “compare and swap,” and string instructions. The present invention is applicable to all such instructions and, in general, is applicable for use with any instruction that exhibits a need for exceptional condition handling.

Additional features and advantages are realized through the techniques of the present invention. Other embodiments and aspects of the invention are described in detail herein and are considered a part of the claimed invention.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a block diagram view illustrating instruction processing for exception handling in the situation in which the present invention is not employed;

FIG. 2 is a block diagram view illustrating instruction processing for exception handling as described in accordance with the method of the present invention;

FIG. 3 is a block diagram illustrating the environment in which the present invention is employed; and

FIG. 4 is a top view of a CD-ROM or other computer readable medium on which the present invention is encoded.

### DETAILED DESCRIPTION

The following Intel A32 architecture code sequence is an example of code which includes a small sequence of rare code in a hot path. The programmer/compiler has to branch around the rare code sequence most of the time:

| | |
|---|---|
| | add eax, ebx ;Add two numbers |
| | jo Ll ;branch to Ll to handle if a rare overflow occurs |
| | -hot-code- |
| | jmp Ldone ;branch-around the rare code |
| Ll: | or eax, 3 |
| Ldone: | |

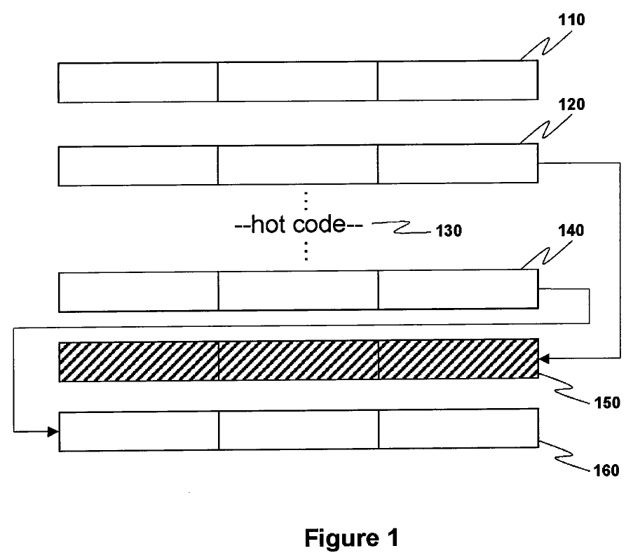

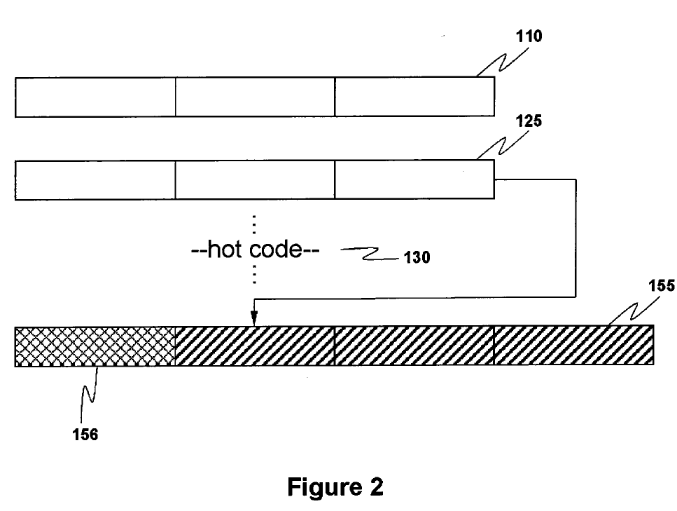

The code above and its concomitant limitations are exemplified in FIG. 1. In particular, there is shown a sequence of computer instructions with each one having one or more fields. At the very low end of the “computer instruction length” spectrum, it might comprise but a single byte. Other instructions have varying sizes. The field sizes and the number of fields shown in FIGS. 1 and 2 is typical and is not meant to suggest that these are the only sizes and numbers that are covered by the scope of the present invention.

In the usual approach, as exemplified in FIG. 1, instruction 110 may perform an arithmetic, logical or other operation that sometimes produces an exceptional condition such as an overflow that must be addressed in another code location such as the “exceptional” code that is shown as instruction 150. In the normal processing modality, the exceptional conditions do not occur and normal processing continues down through “hot code” portion 130. However, in the usual practice there comes a portion of instruction memory where exceptional handling (150) is present and has to be jumped around by instruction 140 which jumps to a location just after instruction 150.

The present approach is to implement the above code as follows:

| | |
|---|---|
| | add eax, ebx ;Add two numbers |
| | jo Ll-3 ;branch to 3 bytes before Ll |
| | -hot-code- |
| | test eax, 0x03C88300 |
| L1: | |

The idea is to use a larger instruction (test in this case) to embed the rare sequence of code. It is noted that the binary encoding of the instruction “or eax, 3” results in the machine code “83 C8 03.” We observe that the binary encoding of the “test” instruction places the 4-byte immediate field at the end of the sequence. We embed this machine code directly inside the immediate field of the instruction. By branching to just the right location inside the “test” instruction it is possible to execute the “or” instruction in the rare cases that it is needed.

The test instruction does not modify any machine state except for the FLAGS register. This technique is used in all places where the FLAGS register is not “live.” It is observed that the FLAGS register on IA32 microprocessors rarely “hold live” across multiple instructions. Accordingly, it is seen that this method is applicable in almost all scenarios. In other words, the “test” instruction is effectively a No-Op at this point in the program because it does not have an impact in observable program state. Also it executes sufficiently fast to make this solution preferable to branching-around.

The improved code structure is illustrated in FIG. 2. In particular, instruction 110 which typically produces an exception condition which must be addressed, is followed by instruction 125 which produces a jump to instruction 155 when the exceptional (that is, rare) condition occurs. Otherwise, processing continues with the execution of the same hot code 130 just as in FIG. 1.

However, importantly for the present invention the code sequence includes instruction 155 which is typically a longer length instruction which includes an immediate field or some other field whose presence is controllably irrelevant to the instruction portion shown in “op code” portion 156. Thus, the leftmost three portions of instruction 155 are employed to store the bit representation of an exception handling instruction. Instruction 155 is also chosen not only to have a field which is ignorable, it is also selected to be an instruction which executes relatively quickly. The code sequence provided above are exemplars of this criteria.

It is possible to use other large instructions that only modify processor state, for example general purpose registers whose contents are never read before being set on all paths reachable from that instruction For example:

| | |
|---|---|
| | add eax, ebx ;Add two numbers |
| | jo Ll-3 ;branch to 3 byte before Ll |
| | -hot-code- |
| | lea edi, [0x03C88300] |
| Ll: | |

The “lea edi, [immediate]” instruction can execute a bit faster than the “test” instruction. However, it destroys the target register (edi in the example above). Accordingly, the method of the present invention can also be employed in circumstances in which there is a register available that does not hold a live value.

This method of the present invention is also applicable in other architectures that support variable instruction lengths such as 390. The principle requirement for the applicability of the present invention is that the architecture support variable length instructions with a longer length instruction being present that includes an “immediate” field or any other field where an arbitrary binary value may be used without causing the instruction to change machine state in some way observable by the program or any field whose presence does not affect the performance or actions of the instruction typically as specified by its “opcode” portion. It is also noted that the present invention does not require that the embedded code which is executed via a jump to it to be embedded in a single field of the dual use instruction. Multiple and overlapping fields are also usable. It is also noted that the present invention may be practiced automatically as with a compiler, an emulator or other similar program that generates sequences of machine instructions. Clearly, in the practice of the present invention also contemplates eventual execution of the encoded instruction, no matter how it may come to be encoded. The encoding of more than one such instruction is also contemplated.

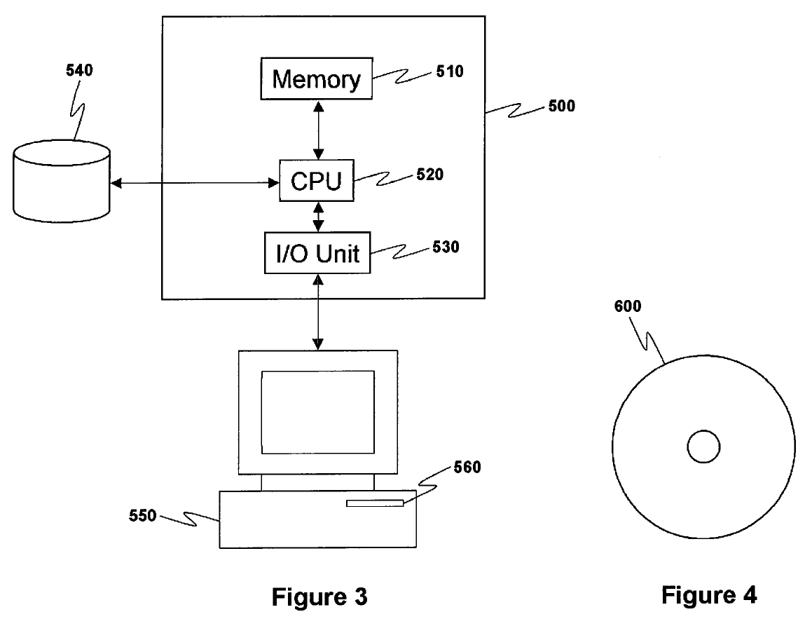

The present invention operates in a data processing environment which effectively includes one or more of the computer elements shown in FIG. 3. In particular, computer 500 includes central processing unit (CPU) 520 which accesses programs and data stored within random access memory 510. Memory 510 is typically volatile in nature and accordingly such systems are provided with nonvolatile memory typically in the form of rotatable magnetic memory 540. While memory 540 is preferably a nonvolatile magnetic device, other media may be employed. CPU 530 communicates with users at consoles such as terminal 550 through Input/Output unit 530. Terminal 550 is typically one of many, if not thousands, of consoles in communication with computer 500 through one or more I/O unit 530. In particular, console unit 550 is shown as having included therein a device for reading medium of one or more types such as CD-ROM 560 shown in FIG. 4. Media 560 may also comprise any convenient device including, but not limited to, magnetic media, optical storage devices and chips such as flash memory devices or so-called thumb drives. Disk 560 also represents a more generic distribution medium in the form of electrical signals used to transmit data bits which represent codes for the instructions discussed herein. While such transmitted signals may be ephemeral in nature they still, nonetheless constitute a physical medium carrying the coded instruction bits and are intended for permanent capture at the signal's destination or destinations.

While the invention has been described in detail herein in accordance with certain preferred embodiments thereof, many modifications and changes therein may be effected by those skilled in the art. Accordingly, it is intended by the appended claims to cover all such modifications and changes as fall within the true spirit and scope of the invention.

What is claimed is:

1. A method for structuring instructions in a stored program computer having instructions of variable length, said method comprising the step of:
encoding an instruction executed on an exceptional basis within one or more fields of a second instruction whose execution is substantially unaffected by coding present in said field.

2. The method of claim 1 in which a single field is employed and in which that field is an immediate field.

3. The method of claim 1 further including the step of executing said instruction.

4. The method of claim 1 in which said encoding is carried out in a data processing system.

5. The method of claim 4 in which said encoding is carried out by stored programming running in said data processing system, said programming being selected from the group consisting of compilers and emulators.

6. A method of operating a stored program digital computer having an instruction set in which not all instructions are of the same length, said method comprising the steps of:
(a) executing a first instruction which has an exception condition to be handled;
(b) subsequently executing a jump instruction on the condition of said exception condition occurring;
(c) executing instructions intended for processing upon the condition that said exception condition does not occur.
(d) executing a further instruction that includes a portion of executable code within itself, said portion of executable code being the destination of said jump instruction.

7. The method of claim 6 in which said first instruction is selected from the group consisting of: atomic instructions, compare and swap instructions, string instructions, arithmetic instructions, logical instructions and shift instructions.

8. The method of claim 6 in which said further instruction includes an immediate field.

9. The method of claim 6 in which said further instruction executes relatively quickly.

10. The method of claim 6 in which said further instruction includes an operational modality for which said portion of executable code is irrelevant.

11. The method of claim 6 in which the steps occur in the order indicated.

12. The method of claim 6 in which step (d) occurs before step (c).

13. The method of claim 6 in which said exception condition occurs rarely.

14. The method of claim 6 in which said exception condition occurs frequently.

15. A method for operating a digital stored program computer comprising the step of executing instructions included in a memory of said computer, said instructions having dual functioning depending on access points for said instructions.

16. A data processing system including a memory for stored program execution by said system, said memory having at least one instruction therein which has dual functions depending on access points for said at least one instruction.

17. A computer readable medium contain instructions thereon which encode at least one instruction which results in an exceptional condition which is handled through the execution of executable code embedded within a second instruction, also contained on said medium, whose execution is substantially unaffected by said embedded code.
